(19) United States
(12) Patent Application Publication
(10) Pub. No.: US 2005/0057367 A1
(43) Pub. Date: Mar. 17, 2005

(54) Alarm system device

(75) Inventor: Thomas J. Regh, Montreal (CA)

Correspondence Address: IP LEGAL DEPARTMENT;TYCO FIRE & SECURITY SERVICES, ONE TOWN CENTER ROAD, BOCA RATON, FL, 33486, US

(73) Assignee: SimplexGrinnell LP, Westminster, MA (US)

(21) Appl. No.: 10/939,018

(22) Filed: Sep. 10, 2004

Related U.S. Application Data
(60) Provisional application No. 60/502,336, filed on Sep. 12, 2003.

(51) Int. Cl. G08B 23/00

(52) U.S. Cl. 340/693.6; 340/628

(57) ABSTRACT

A building system field device includes a base unit, a protective cover, a head unit and an alarm device. The base unit mounts inside an electrical box, and includes electrical terminals for connecting to field wiring. The base unit provides sufficient functionality to permit testing of the building wiring without the head unit being attached. The protective cover protects the base unit during drywall installation and is removed when the head unit is installed.

### RELATED APPLICATION(S)

This application claims the benefit of U.S. Provisional Application No. 60/502,336, filed Sep. 12, 2003. The entire teachings of the above application(s) are incorporated herein by reference.

### BACKGROUND

During construction of new buildings, electronic devices such as smoke detectors and fire alarm notification appliances must be mounted and wired throughout the structure. This work cannot usually occur until after the drywall and painting has been completed on the walls and ceilings, because each device contains a cosmetic flange to hide the gap between the drywall and the corresponding electrical box. This sequenced approach results in a lengthier installation time, and places the electronic system installation and check-out on critical path towards obtaining the building occupancy certificate.

Existing two-piece smoke detector designs consist of a base and sensor head. The base mounts to the electrical box, and also provides the aesthetic function of hiding the gap between the finished wall (or ceiling) and the electrical box. Depending on the manufacturer, the base may or may not contain electronics. The sensor head installs into the base to form a complete unit.

### SUMMARY OF THE INVENTION

It is desirable to be able to install the fire alarm devices and to begin testing of the wiring and devices while the drywall and painting work is taking place (in parallel). Under those conditions, the fastest possible installation and checkout can occur.

The present invention offers a new approach in which the mechanical packaging of fire alarm peripheral devices is an adaptation of the approach used by the electrical lighting control industry. The present invention is unique, however, in that the electronics may be partitioned into both the base and head. (In the case of a light switch, the “head” is merely a cosmetic cover plate.)

A feature of the present invention is that the base unit fits within the X-Y dimensions of the electrical box, while a cosmetic flange is integral to the head unit. This scheme allows the fire alarm system installation technician to complete the device installation and check-out in parallel with the drywall and painting tradesmen performing their finishing work. This results in significantly shorter installation times, and prevents the fire alarm system from becoming the limiting factor in obtaining the building occupancy certificate.

In accordance with an embodiment of the present invention, a building system field device comprises a base unit, a protective cover, a head unit and an alarm device. The base unit mounts inside an electrical box, and includes electrical terminals for connecting to field wiring. The base unit provides sufficient functionality to permit testing of the building wiring and devices for common defects such as shorts, opens, ground faults, mis-addressed devices, etc., without the head unit being attached. The protective cover protects the base unit during drywall installation and is removed when the head unit is installed, generally after the wall or ceiling surface installation and finishing has been completed. The alarm device may be either in the base unit or the head unit, but in either case communicates through the base unit to the field wiring.

The alarm device may include, but is not limited to, an annunciator or notification device such as a siren, horn, speaker, strobe, etc., or a sensor such as a smoke, fire, heat, flame or gas detector or intrusion sensor, or any combination of these devices. The building system field device may further provide an air-tight seal such that pressurized air from the electrical wiring conduit does not prevent smoke from entering the sensor chamber.

The base unit may be housed completely within a standard electrical box. Alternatively, it may protrude into building occupied space to provide additional room in the electrical box for wiring, provided that the base unit does not overlap the finished wall. An adapter can be used to mount said device to the electrical box.

Electrical terminals are accessible from the front of the base unit after mechanical mounting of said field device to simplify testing and hookup. The base unit may include means for setting and/or storing a unique device address.

The base unit of one embodiment further includes means for mechanically attaching the head unit to the base unit without requiring tools.

The base unit of one embodiment provides an indicator such as a light source (e.g., an LED) or an audible source, to convey status information. The head unit includes a light pipe that transmits an optical signal from the light source for viewing after the head unit is installed.

The head unit includes an integral cosmetic flange to hide a gap between the electrical box and a finished ceiling or wall surface.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a mechanical drawing illustrating the mounted base of an embodiment of the present invention with a protected cover.

FIG. 2 is a mechanical drawing illustrating the mounted base of FIG. 1 with a head unit installed.

FIG. 3 is a perspective drawing illustrating the components and assembly of the embodiment of FIGS. 1 and 2.

### DETAILED DESCRIPTION

An embodiment of the present invention introduces a novel mechanical packaging scheme for building system field devices that enables installation and testing of such devices in parallel with the finish work for the walls and ceilings. The installed devices do not interfere with the contractors performing the finish work on the walls and ceilings, yet enable the electrical contractor to begin mounting and testing devices immediately after the electrical boxes have been mounted and the wire pulled. The solution is based upon a two-piece design, consisting of a base and head.

FIG. 1 is a mechanical drawing illustrating the mounted base of an embodiment of the present invention with a protected cover. Ceiling or wall drywall 3 is attached to ceiling joists or wall studs 1. A cutout 11 is made in the drywall 3 to accommodate a building system field device such as a fire, smoke, or other hazard detector, or an annunciator such as a horn, speaker, strobe, etc. A standard electrical box 5 is installed in the cutout 11.

Prior to or while finishing the ceiling or wall surface 3, e.g., taping, plastering, sanding, painting, etc., a sensor base 7 according to an embodiment of the present invention is installed within the electrical box 5. The sensor base 7 may include, for example, a printed circuit board 9 having front access terminals. A protective cover 13 is mounted to the sensor base 7 and/or the electrical box 5. The protective cover 13 serves to protect the sensor base 7 and the electrical box 5 from dust, paint and other harmful or foreign elements while installation or construction work on the surface 3 or elsewhere within the room continues. The protective cover 13 may be reusable or disposable.

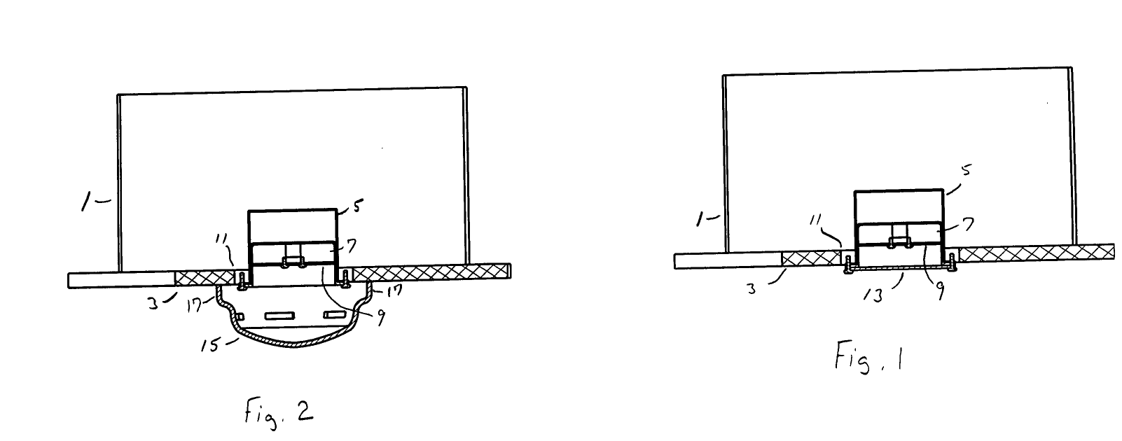

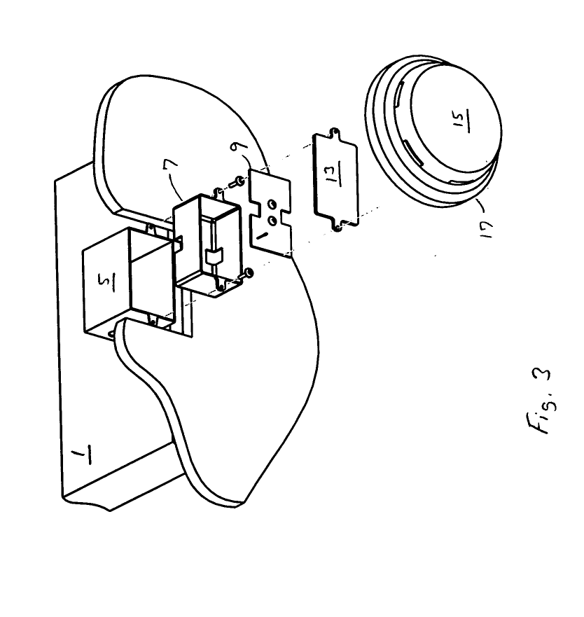

FIG. 2 is a mechanical drawing illustrating the mounted base of FIG. 1 with a head unit 15 installed. After installation of the ceiling 3 is complete, e.g., after it has been painted, the protective cover 13 (FIG. 1) is removed, and the head unit 15 attached to the sensor base (base unit) 7. In the illustrated embodiment, the head unit 15 mounts flush against the ceiling surface 3, hiding the electrical box cutout 11 and preventing airflow from inside the ceiling.

FIG. 3 is a perspective drawing illustrating the components and assembly of the embodiment of FIGS. 1 and 2. Reference numbers correspond to those used in FIGS. 1 and 2.

Sensor Base (Base Unit)

In one embodiment, the base unit 7 mounts to, and is housed completely within, a standard electrical box 5. Alternatively, the base unit 7 can protrude into the occupied space of the building to provide additional room in the electrical box 5 for wiring, provided that it does not overlap the finished wall or ceiling surface 3. In further embodiments, adapters can be used as necessary to enable mounting to a variety of standard electrical boxes.

The base unit 7 can be protected by a removable, disposable (or reusable) cover 13 that prevents construction debris or paint from damaging the unit once installed.

The base unit 7 may include electrical terminals (accessible from the front after mechanical mounting) for attaching field wiring. It may further contain means for setting and/or storing a unique device address or other identifying code.

In one embodiment, a head unit 15 can be mechanically attached to the base unit 7, preferably without requiring tools. The attachment scheme must take into account variable electrical box mounting depth, relative to the finished face of the wall or ceiling.

In one embodiment, the base unit 7 includes a sensor. In another embodiment, the head unit 15 includes the sensor, in which case the base unit 7 includes electrical contacts for interfacing with the head. In either case, the base unit 7 provides sufficient functionality, without the head unit 15 installed, to permit a complete check-out of the building wiring and alarm system for opens, shorts, ground faults, address problems and the like.

The printed circuit board 9 within the base unit 7 may contain a light emitting diode (LED) or other light source, or an audible source, to convey status information.

Head Unit

The head unit 15, according to an embodiment of the present invention, attaches securely to the base unit 7, preferably without requiring tools for installation, for example using by employing snap fits, twist locks, or a ratcheting mechanism, and may contain an integral cosmetic flange 17 to hide the gap between the electrical box 5 and the finished wall or ceiling 3.

The head unit 15 may contain a smoke sensor chamber or other hazard sensors. In addition, it can provide an air-tight seal so that air from a pressurized electrical conduit does not prevent smoke from entering the sensor chamber.

Finally, the head unit 15 of at least one embodiment contains a light pipe to transmit an optical signal form the printed circuit board 9 for viewing after head unit 15 is installed.

1. A building system field device, comprising:
a base unit for mounting inside an electrical box, the base unit comprising electrical terminals for connecting to field wiring, and providing sufficient functionality to permit testing of the building wiring without a head unit being attached;
a protective cover which protects the base unit during drywall installation and which is removed when the head unit is installed;
said head unit, which is attached to the base unit after drywall installation; and
an alarm device communicating with the base unit.

2. The building system field device of claim 1, the alarm device comprising an annunciator.

3. The building system field device of claim 1, the alarm device comprising a sensor.

4. The building system field device of claim 3, the base unit comprising the sensor.

5. The building system field device of claim 3, the head unit comprising the sensor.

6. The building system field device of claim 3, wherein the sensor includes a smoke sensor chamber.

7. The building system field device of claim 6, further comprising an air-tight seal such that air from a pressurized conduit is prevented from entering the sensor chamber.

8. The building system field device of claim 1, wherein said device is a fire alarm system device.

9. The building system field device of claim 1, wherein the base unit is housed completely within, a standard electrical box.

10. The building system field device of claim 1, wherein the base unit protrudes into building occupied space to provide additional room in the electrical box for wiring, provided that the base unit does not overlap the finished wall.

11. The building system field device of claim l, an adapter being used to mount said device to the electrical box.

12. The building system field device of claim 1, wherein the electrical terminals are accessible from the front of said field device after mechanical mounting of said field device.

13. The building system field device of claim 1, the base unit further comprising means for setting a unique identifying code.

14. The building system field device of claim 1, the base unit further comprising means for storing a unique identifying code.

15. The building system field device of claim 1, the base unit further comprising means for mechanically attaching the head unit to the base unit without requiring tools.

16. The building system field device of claim 1, the base unit further comprising an indicator to convey status information.

17. The building system field device of claim 16, wherein the indicator is a light source.

18. The building system field device of claim 17, the head unit further comprising a light pipe which transmits an optical signal from the light source for viewing after the head unit is installed.

19. The building system field device of claim 16, wherein the indicator is an audible indicator.

20. The building system field device of claim 1, wherein the head unit includes an integral cosmetic flange to hide a gap between the electrical box and a finished surface.

21. A building system field device base unit for mounting inside an electrical box, the base unit comprising:
electrical terminals for connecting to field wiring;
sufficient functionality to permit testing of the building wiring without a head unit being attached;
means for attaching a protective cover to protect the base unit during drywall installation;
means for attaching a head unit; and
means for communicating with an alarm device.

22. A building system field device head unit, comprising:
an alarm device;
means for mechanically connecting to a base unit mounted inside an electrical box, the base unit comprising electrical terminals for connecting to field wiring, wherein the base unit provides sufficient functionality to permit testing of the building wiring without the head unit being attached;
means for electrically connecting the alarm device to the base unit; and
an integral cosmetic flange to hide a gap between the electrical box and a finished surface.

23. A method for installing a building system field device, the method comprising:
mounting a base unit of the building system field device inside an electrical box;
electrically connecting the base unit to the building wiring;
testing, without a head unit installed, and with a protective cover protecting the base unit, the building wiring; and
after testing, mounting the head unit to the base unit, the head unit comprising at least one sensor device.

24. A building system field device, comprising:
base means mountable inside an electrical box, said base means comprising means for electrically connecting to the building wiring, and said base means providing sufficient functionality to permit testing of the building wiring;
sensor means for sensing an environmental condition; and
connection means for mechanically and electrically attaching said sensor means to said base means.
